(19) United States
(12) Patent Application Publication
(10) Pub. No.: US 2006/0080708 A1
(43) Pub. Date: Apr. 13, 2006

(54) Electronic program guide and method of display

(76) Inventors: Akira Miyazawa, Saitama-shi (JP); Takashi Nakamura, Mitaka-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/084,652

(22) Filed: Mar. 18, 2005

(30) Foreign Application Priority Data
Sep. 27, 2004 (JP) 2004-280478

(51) Int. Cl. H04N 7/173; H04N 5/445; G06F 13/00; G06F 3/00; H04N 5/44

(52) U.S. Cl. 725/39; 725/37; 725/100; 348/725

(57) ABSTRACT

According to one embodiment, a digital television receiver comprises an on-screen display (OSD) generator, a controller and a processor. Operating in combination with the OSD generator, the controller is adapted to produce an electronic program guide displaying programs. The electronic program guide includes a display window in a first display mode, where program data corresponding to a selected channel of a plurality of channels provided by a first broadcast station is displayed in the display window as a representative channel. The processor is adapted to output the electronic program guide and to output information to indicate to a viewer that the selected channel is the representative channel.

### CROSS-REFERENCE TO RELATED APPLICATIONS

This application is based upon and claims the benefit of priority from prior Japanese Patent Application No. 2004-280478, filed Sep. 27, 2004, the entire contents of which are incorporated herein by reference.

### BACKGROUND

1. Field

Embodiments of the present invention relate to an electronic program guide output apparatus, an electronic program guide displaying apparatus, and an electronic program guide displaying method configured for use in a digital television receiver or the like.

2. Description of the Related Art

As is well known, digitization of the existing television broadcasting services have being expedited worldwide. In Japan, terrestrial digital broadcasting services are now beginning to being digitized similar to current BS (broadcast satellite) broadcasting services and CS (communication satellite) digital broadcasting services.

In the digital television broadcasting services, a digital television receiver produces and displays an electronic program guide from the data of EPG (electronic program guide) in its received broadcast signal. This allows a user to monitor and select programs from the electronic program guide displayed on the screen of the television receiver for viewing or unattended recording.

The EPG data include various program data of each broadcasting channel enough to produce an electronic program guide for about one full week. The program data may include, but is not limited or restricted to a title, a start time, an end time, a channel number, a descriptive text summary of the content, and a content type (e.g., sports, drama, etc.).

As the display screen of the digital television receiver is limited, it can display a given size of the program data but not all the electronic program guide. In practice, the electronic program guide is displayed through switching from one frame to another. It would be advantageous, however, to display as much data of the electronic program guide as possible on the limited screen size or improve the visuality and legibility of the program data.

A digital television receiver is disclosed in Jpn. Pat. Appln. KOKAI Publication No. 2001-145043 of which the attempt is to improve the visuality of program data when one program is broadcasted over two or more channels and its data is distributed to each of the two or more channels.

Another digital television receiver is disclosed in Jpn. Pat. Appln. KOKAI Publication No. 2001-111907 where a user can be notified of the data about all SDTV programs distributed over a transport stream assigned to the currently selected SDTV program channel.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary schematic view of a digital television receiver and network systems connected with the digital television receiver, showing a first embodiment of the present invention;

FIG. 2 is an exemplary block diagram illustrating a primary signal processing system in the digital television receiver of the first embodiment;

FIG. 3 is an exemplary illustration of a remote control for the digital television receiver of the first embodiment;

FIG. 4 is a flowchart showing an exemplary procedure for displaying an electronic program guide on the digital television receiver of the first embodiment;

FIG. 5 is a flowchart showing another exemplary procedure for displaying an electronic program guide on the digital television receiver of the first embodiment;

FIG. 6 is an illustration of the exemplary electronic program guide displayed on the digital television receiver of the first embodiment;

FIG. 7 is a flowchart showing an exemplary procedure for switching a channel display window from the selected channel display mode to the full channel display mode on the digital television receiver of the first embodiment;

FIG. 8 is a flowchart showing an exemplary procedure for switching the channel display window from the full channel display mode to the selected channel display mode on the digital television receiver of the first embodiment;

FIG. 9 is an exemplary illustration of an electronic program guide displayed on a digital television receiver according to a second embodiment of the present invention;

FIG. 10 is a flowchart showing an exemplary procedure for switching a channel display window from the selected channel display mode to the full channel display mode on the digital television receiver of the second embodiment;

FIG. 11 is a flowchart showing an exemplary procedure for switching the channel display window from the full channel display mode to the selected channel display mode on the digital television receiver of the second embodiment;

FIG. 12 is an exemplary illustration of a modification of the electronic program guide displayed on the digital television receiver of the second embodiment;

FIG. 13 is an exemplary illustration of an electronic program guide displayed on a digital television receiver according to a third embodiment of the present invention; and

FIG. 14 is a view illustrating an exemplary transition of the electronic program guide switched with the use of a remote control of the digital television receiver of the second embodiment.

### DETAILED DESCRIPTION

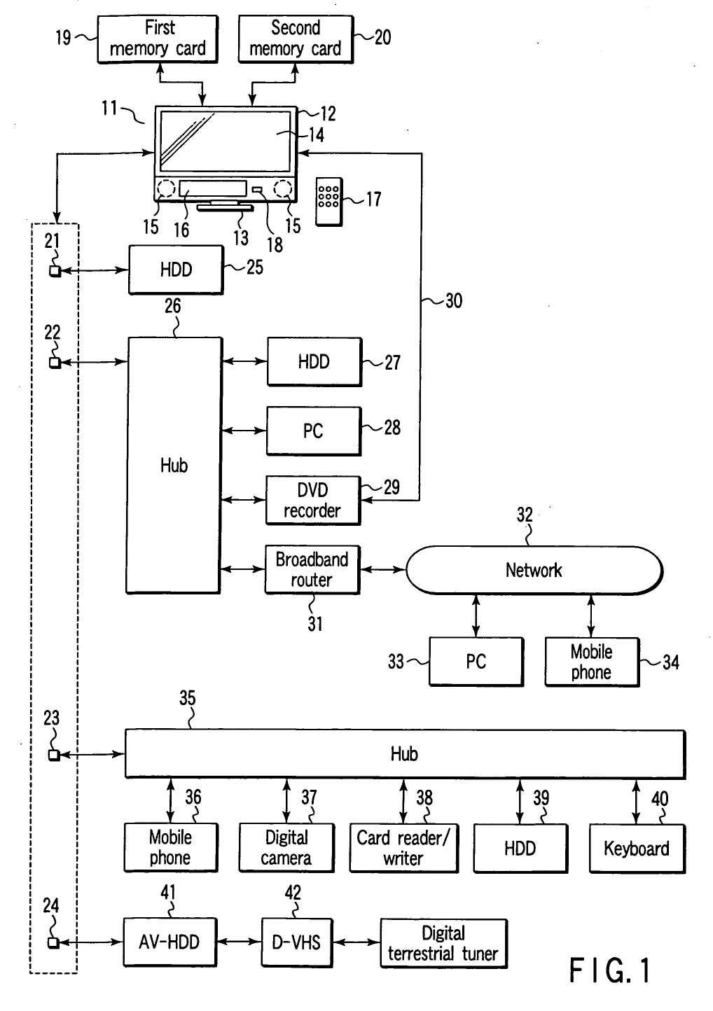

The first embodiment of the present invention will be described in more detail referring to the relevant drawings. FIG. 1 schematically illustrates a digital television receiver 11 and an example of a network system including the digital television receiver 11 for explaining the first embodiment of the present invention.

According to one embodiment of the invention, the digital television receiver 11 comprises a housing that includes a cabinet 12 and a support base 13 supporting the cabinet 12 in an upright position. The cabinet 12 contains a flat panel display 14 (e.g., a liquid crystal display, plasma display, a flat screen cathode ray tube monitor, etc.), a set of loudspeakers 15, an operation panel 16, and a light receiver 18 for receiving commands from a remote control 17.

The digital television receiver 11 is configured with a detachable first memory card 19. The first memory card 19 can save various data of television programs and photographs for playback. Examples of the first memory card 19 include, but are not limited or restricted to a secure digital (SD) card, PCMCIA card, or a multimedia card (MMC).

The digital television receiver 11 is arranged where a second (IC) memory card 20 having a semiconductor memory built therein for carrying, for example, a subscriber contract which can be loaded and unloaded. The second memory card 20 can erasably save such specific data.

The digital television receiver 11 includes a first LAN (local area network) port 21, a second LAN port 22, a USB (universal serial bus) port 23, and an i-Link port 24.

The first LAN port 21 is provided as a LAN dedicated HDD (hard disk drive) port, which can be connected to a network attached storage (NAS) or LAN dedicated HDD 25 over a network for recording and playback of the data. Examples of the network include, but are not limited or restricted to Ethernet, Asynchronous Transfer Mode (ATM), Token Ring and the like.

The first LAN port 21 acting as the LAN dedicated HDD port permits the digital television receiver 11 to record and play back the programs of high definition images on the HDD 25 regardless of the environmental situation and communication with other networks.

The second LAN port 22 is provided as a common LAN dedicated port over the network. The second LAN port 22 may be connected by a hub 26 to a LAN dedicated HDD 27, a PC (personal computer) 28, an HDD equipped DVD (digital versatile disk) recorder 29, and so on for exchange of digital data.

When the DVD recorder 29 is connected to the second LAN port 22 which can control only commands of a digital format, its analog transmission line 30 has to be provided to communicate directly with the digital television receiver 11 for exchange of analog video and audio data.

The second LAN port 22 is also in communication with another network 32 such as the Internet by a broadband router 31 connected to the hub 26. This allows the digital television receiver 11 to communicate with PCs 33 and mobile phones 34 over the network 32.

The USB port 23 is provided as a common USB port and may be communicated via the hub 35 to a variety of USB-based appliances including a mobile phone 36, a digital camera 37, a memory card reader/writer 38, another HDD 39, and a keyboard 40 for exchange of digital data.

The i-Link port 24 is provided for serial connection with, for example, an AV-HDD 41, a D(digital)-VHS (video home system) 42, and a digital terrestrial tuner.

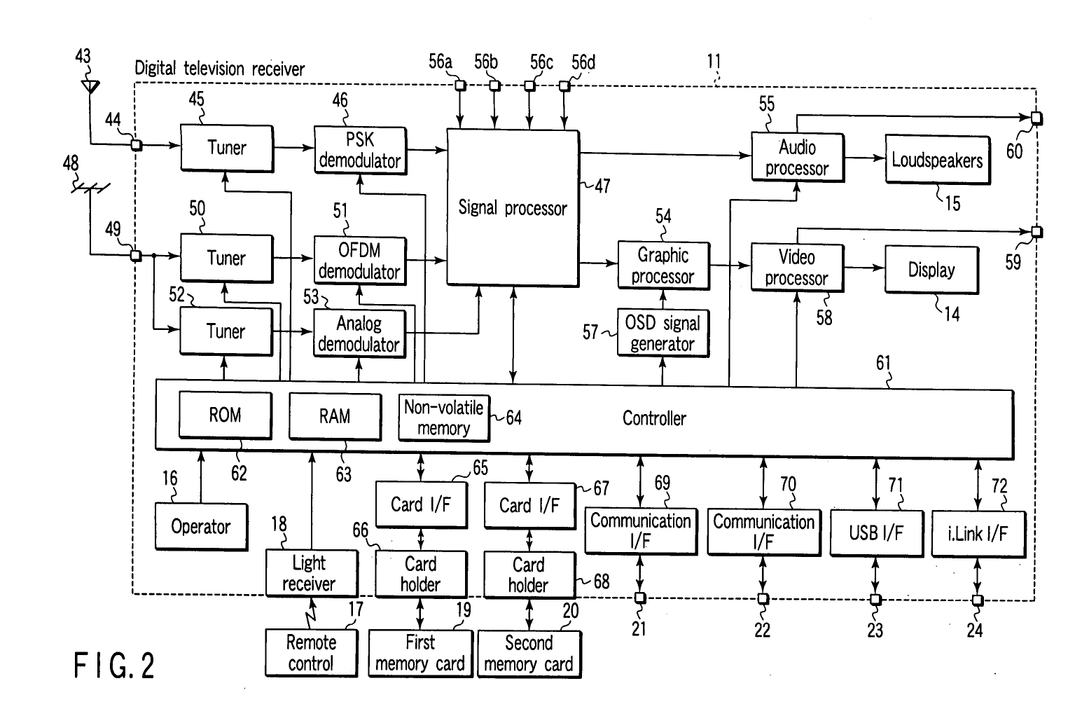

FIG. 2 illustrates a main signal processing system in the digital television receiver 11. A digital satellite television broadcast signal is received at an antenna 43 for the BS/CS digital television broadcasting services and transferred via an input port 44 to a digital satellite broadcast tuner 45 where it is tuned to extract a desired channel of the television broadcasting service.

The broadcast signal extracted by the tuner 45 is transferred to a PSK (phase shift keying) demodulator 46 where it is demodulated to digital video and audio signals which are then received by a signal processor 47.

A digital terrestrial television broadcast signal (or cable signal) is received at an input device 48 (e.g., antenna or cable box) for the digital terrestrial digital broadcasting services and transferred via an input port 49 to a digital ground broadcast tuner 50. Tuner 50 is configured to extract a desired channel of the television broadcasting service.

The broadcast signal extracted by the tuner 50 is transferred to an OFDM (orthogonal frequency division multiplexing) demodulator 51 where it is demodulated to digital video and audio signals which are then received by the signal processor 47.

Also, an analog ground television broadcast signal is received at the input device 48 (e.g., cable box or antenna as shown) and transferred via the input port 49 to an analog ground broadcast tuner 52. Tuner 52 extracts a desired channel of the television broadcasting service. The broadcast signal extracted by the tuner 52 is transferred to an analog demodulator 53 where it is demodulated to analog video and audio signals, which are then received by the signal processor 47.

The signal processor 47 carries out an action of digitally processing the digital video and audio signals received from each of the PSK demodulator 46 and the OFDM demodulator 51 before transmitting processed outputs to a graphic processor 54 and an audio processor 55.

The signal processor 47 is also connected to a number (four in the embodiment) of input ports 56a, 56b, 56c, and 56d for receiving extra analog video and audio signals from the outside of the digital television receiver 11.

The analog video and audio signals received from the analog demodulator 53 or the input ports 56a to 56d are first digitized and subjected to the digital processing action in the signal processor 47 before transmitted to the graphic processor 54 and the audio processor 55. It is contemplated, however, that analog-to-digital conversion may be handled by a separate component in lieu of being handled by signal processor 47.

The graphic processor 54 has a function of superimposing an OSD (on-screen display) signal produced by an OSD signal generator 57 over the digital video signal received from the signal processor 47. More particularly, the graphic processor 54 can selectively pass the video signal from the signal processor 47 and the OSD signal from the OSD signal generator 57 and release a combination of the two signals for displaying separately on the screen at two halves of the display.

The digital video signal released from the graphic processor 54 is received by a video processor 58. The video processor 58 is provided for converting the digital video signal into an analog form to be displayed on the display 14 and transferring the analog video signal to the display 14 and via an output port 59 to the outside.

The audio processor 55 is provided for converting the digital audio signal into an analog form to be emitted from the loudspeakers 15 and transferring the analog audio signal to the loudspeakers 15 and via an output port 60 to the outside.

All the actions of the digital television receiver 11 including the reception of the signals are entirely controlled by a controller 61. The controller 61 includes a processor (e.g., central processing unit “CPU”, application specific integrated circuit “ASIC” or programmable logic device “PLD”) for receiving commands directly from the operation panel 16 or via the light receiver 18 from the remote control 17 and conducting the control actions in response to the commands.

The controller 61 also has a ROM (read only memory) 62 where control programs for the processor are stored, a RAM (random access memory) 63 for providing the processor with working areas, and a non-volatile memory 64 where setting data and control data are stored.

The controller 61 is connected by a card I/F (interface) 65 to a card holder 66 to which the first memory card 19 is detachably loaded. This allows the controller 61 to exchange the data via the card I/F 65 with the first memory card 19 loaded in the card holder 66.

Also, the controller 61 is connected by another card I/F (interface) 67 to a card holder 68 to which the second memory card 20 is detachably loaded. This allows the controller 61 to exchange the data via the card I/F 67 with the second memory card 20 loaded in the card holder 68.

Moreover, the controller 61 is connected by a communication I/F 69 to the first LAN port 21. This allows the controller 61 to exchange the data with the LAN dedicated HDD 25 via the communication I/F 69 and the first LAN port 21. For this action, the controller 61 has a DHCP (dynamic host configuration protocol) server function for assigning the LAN dedicated HDD 25, connected to the first LAN port 21, with an IP (Internet protocol) address.

Similarly, the controller 61 is connected by another communication I/F 70 to the second LAN port 22. This allows the controller 61 to exchange the data with the other devices (shown in FIG. 1) via the communication I/F 70 and the second LAN port 22.

The controller 61 is connected by a USB I/F 71 to the USB port 23. This allows the controller 61 to exchange the data with the other devices (shown in FIG. 1) via the USB I/F 71 and the USB port 23.

The controller 61 is connected by an i-Link I/F 72 to the i-Link port 24. This allows the controller 61 to exchange the data with the other devices (shown in FIG. 1) via the i-Link I/F 72 and the i-Link port 24.

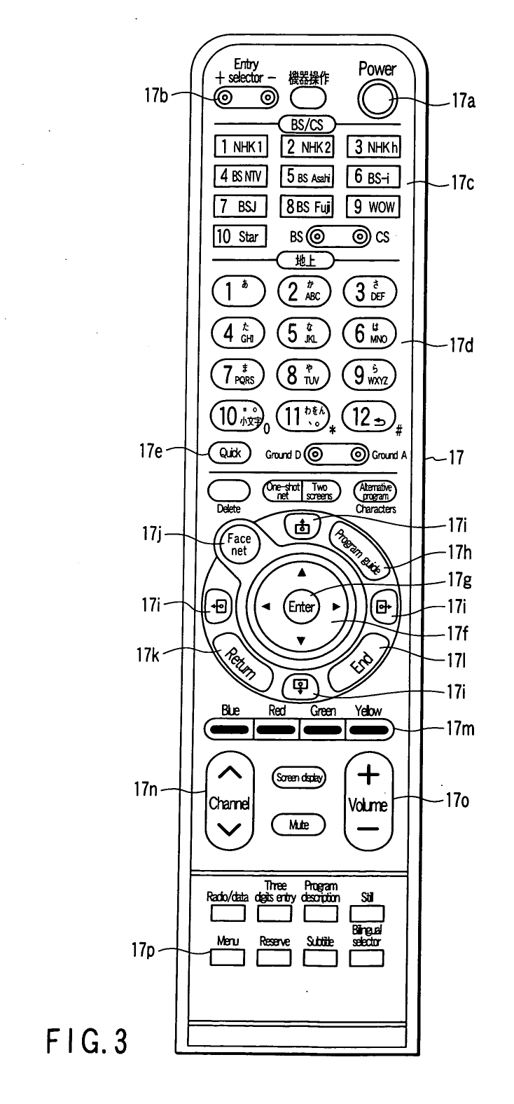

FIG. 3 is an external view of the remote control 17. The remote control 17 includes a power key 17a, an entry selector key 17b, an array of digital satellite broadcasting channel direct select keys 17c, an array of terrestrial broadcasting channel direct select keys 17d, a quick key 17e, a cursor key 17f, an enter key 17g, a program guide key 17h, a group of page select keys 17i, a face net (navigation) key 17j, a return key 17k, an end key 17l, a group of blue, red, green, and yellow color keys 17m, a channel up/down key 17n, a volume key 17o, and a group of menu keys 17p.

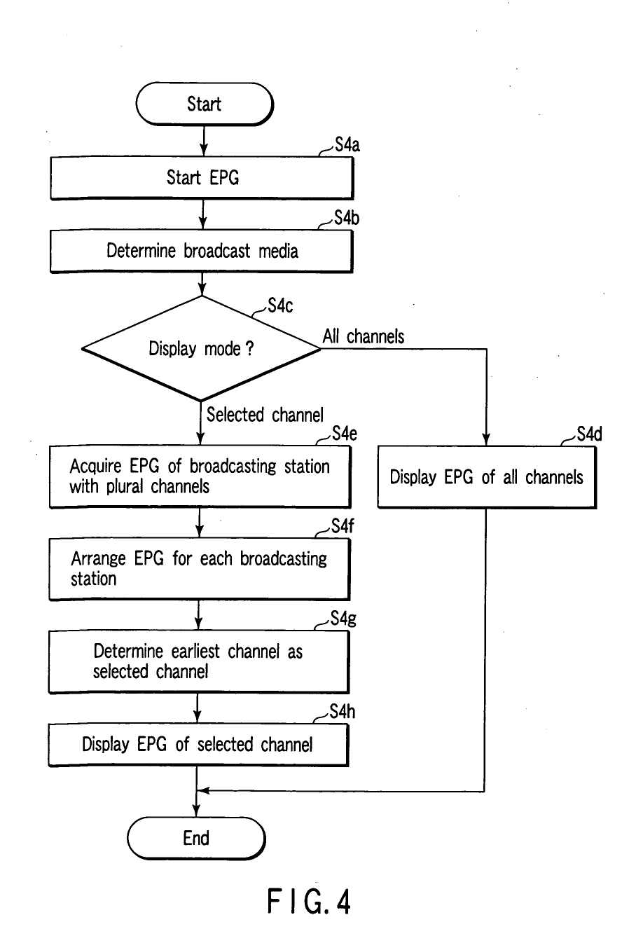

FIG. 4 is a flowchart showing the action of the digital television receiver 11 displaying an electronic program guide according to the first embodiment. The action starts with a user operating the program guide keys 17h and the color keys 17m on the remote control 17 to initiate the EPG process (block S4a). In block S4a, the EPG data carrying the program data is received over the network or from the memory card.

The controller 61 then determines a type of the broadcasting media (block S4b). In block S4b, the broadcasting media is determined from the television broadcasting service, the radio broadcasting service, and the data broadcasting service. The controller 61 examines the display mode of the EPG screen (block S4c). When the full channel display mode is selected, a guide of programs at all the broadcasting channels is displayed (block S4d).

The full channel display mode will now be described in more detail. The description is made with but not limited to all the channels. The display may be of all receivable channels or any desired number of the channels (not all the channels), which are grouped on the basis of the content of the programs.

The display mode in the embodiment is classified into two different modes; namely, full channel display mode and the selected channel display mode. In practice, provided simultaneously in a given range of the television broadcasting frequencies assigned to one television broadcasting station may be two or more of the SD (standard) channels and one of the HD (high definition) channel.

The selected channel display mode is designed for displaying a guide of programs on selected one of the broadcasting channels provided by a single SD television broadcasting station. Therefore, the number of television broadcasting stations to be displayed can be increased. For example, while the display of the program guide remains common for a television broadcasting station which offers a single broadcasting channel, a guide of the programs on one selected channel can be displayed for a particular television broadcasting station, e.g., the existing SD broadcasting station, which offers two or more broadcasting channels. More specifically, the particular television broadcasting station may provide the digital terrestrial digital broadcasting service as well as the standard or analog terrestrial digital broadcasting service.

When the selected channel display mode is selected in block S4c, the controller 61 extracts (from the received EPG data) data of the television broadcasting stations which offer two or more (plural) channels (block S4e) and guides up the EPG data of each of the television broadcasting stations (block S4f). This is followed by selecting the earliest channel of each of the television broadcasting stations (block S4g) and displaying the EPG data of the selected channel (block S4h).

The selected channel may represent the television broadcasting station, which offers two or more channels and is not limited to the earliest channel. For example, the selected channel of each television broadcasting station may be arbitrarily predetermined at the initial setting by the user operating the remote control 17. The selected channel may also be determined depending on the last displayed channel and the date of its display. Simply, the selected channel may be a channel assigned with the smallest or largest channel number. When the selected channel is not assigned as a subscriber channel to the user or is an out-of-contract channel, it may be skipped or replaced with the other subscriber channel.

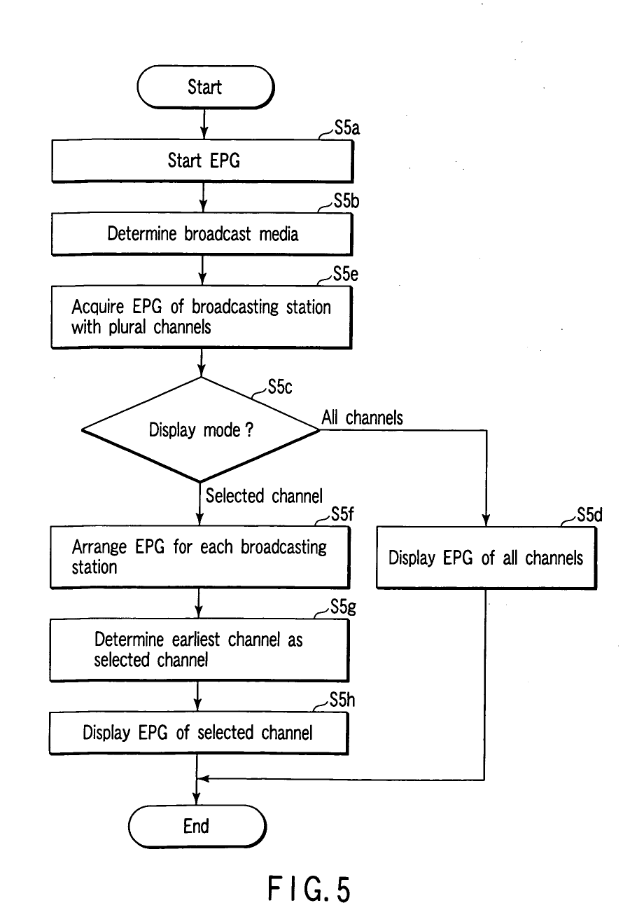

FIG. 5 is a flowchart showing another action of displaying the guide of programs according to the first embodiment. In block S5c of the action, the display mode is determined for each television broadcasting station. This is effective when the television broadcasting station is assigned with either the full channel display mode or the selected channel display mode. This setting can be made systematically or registered in advance by the user. Accordingly, the system can be media seamless.

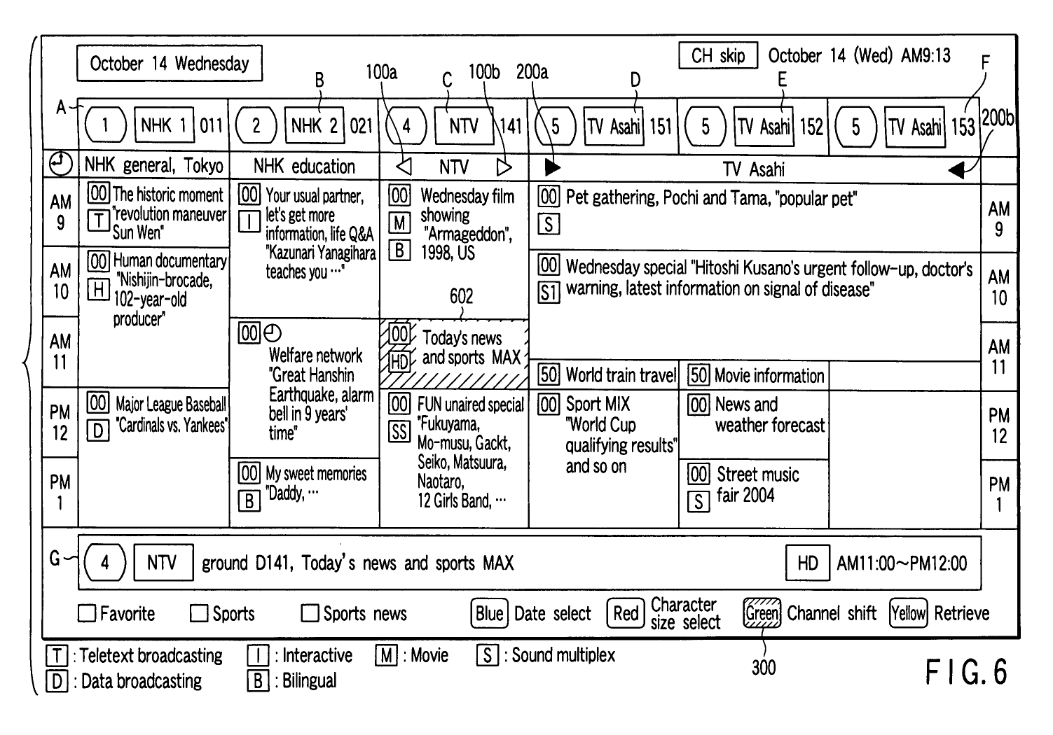

FIG. 6 illustrates an example of the electronic program guide on the display screen according to the first embodiment. The screen displays both the full channel display mode and the selected channel display mode.

The electronic program guide exhibits six television broadcasting channels A, B, C, D, E, and F along the horizontal. Shown along the vertical is a time table of five hours at each channel (program).

For example, as shown for illustrative purposes, the channel A is the NHK (Japan Broadcasting Corporation) 1 station (numbered by 011), the channel B is the NHK 2 station (numbered by 021), the channel C is the NTV (Nippon Television Network Corporation) station (numbered by 141), the channel D is the TV Asahi (TV Asahi Corporation) station (numbered by 151), the channel E is the TV Asahi station (numbered by 152), and the channel F is the TV Asahi station (numbered by 153).

The channel C of the NTV (channel 141) represents a selected channel with an image to represent the presence of additional channels. The window hence displays the selected channel display mode. More specifically, according to this embodiment of the invention, two substantially triangle symbols 100a and 100b are provided at both sides of the window at the channel C of the NTV station for indicating that the window can be extended outwardly. This allows the user to monitor other channels of the station if desired.

More particularly, the window on the screen shown in FIG. 6 exhibits the selected one (channel 141) of the three television broadcasting channels (numbered by 141, 142, and 143) assigned to the NTV station.

The channels D, E, and F (channel 151, 152, and 153) assigned to the TV Asahi station are hence displayed in the full channel display mode. As described, the display may be made either in the full channel display mode or the selected channel display mode or in a group of the channels determined over the content of the programs.

As shown, two substantially triangle symbols 200a and 200b are provided at both sides of the window of the TV Asahi station through the three channels D, E, and F for indicating that the window can be extended outwardly. The window hence displays the full channel display mode. This allows the user to monitor all the channels of the station at once. Of course, it is contemplated that other images, other than triangle symbols, may be used to denote that the window can be extended outwardly to view all of the channels for a particular station at once.

As described, the window of the TV Asahi station is at the full channel display mode showing all the channels D, E, and F (channel 151, 152, and 153) assigned to the station. When the window of the TV Asahi station can be shifted from the full channel display mode to the selected channel display mode, it can display the selected channel like the window of the NTV station showing the channel 141 at the channel C.

The shift from the selected channel display mode to the full channel display mode or from the full channel display mode to the selected channel display mode can be done by the user operating the channel shift button (the green color key 17m in the embodiment).

In other words, the electronic program guide can be scrolled upwardly, downwardly, leftwardly and rightwardly by the user operating the cursor key 17f on the remote control 17. Alternatively, using the page select keys 17i on the remote control 17, the electronic program guide can selectively be skipped by one screen in all the four, upward, downward, leftward, and rightward, directions. Moreover, using the function of shifting the date and time setting, the program guide can be switched to a desired screen at the date and time setting.

Also, when the broadcasting station provides two or more channels (the TV Asahi station having three channels in the embodiment), its display window extends to be common to the three different stations as denoted by the D, E, and F in FIG. 6.

When a plurality of (plural) channels of the broadcasting station (e.g., three channels 151-153 of the TV Asahi station in the embodiment) offer a single program as a common event in a given duration of time, their windows assigned to the three channels D, E, and F can be combined to one common window for displaying the single program.

The electronic program guide also exhibits beneath the six windows A to F a selected program display area G for displaying the channel, the title, and the on-air time of a program 602 selected by the user operating the cursor key 17f on the remote control 17.

The time table shown at both, left and right, sides in the electronic program guide is divided vertically into five hour segments. The hour segments shown in FIG. 6 extend from nine A.M. to one P.M. When the time is at ten A.M., the hour segments are shifted to extend from ten A.M. to two P.M.

Upon detecting the activation of the green color key 17m on the remote control 17, the controller 61 switches from the full channel display mode to the selected channel display mode or vice versa on the screen of the electronic program guide.

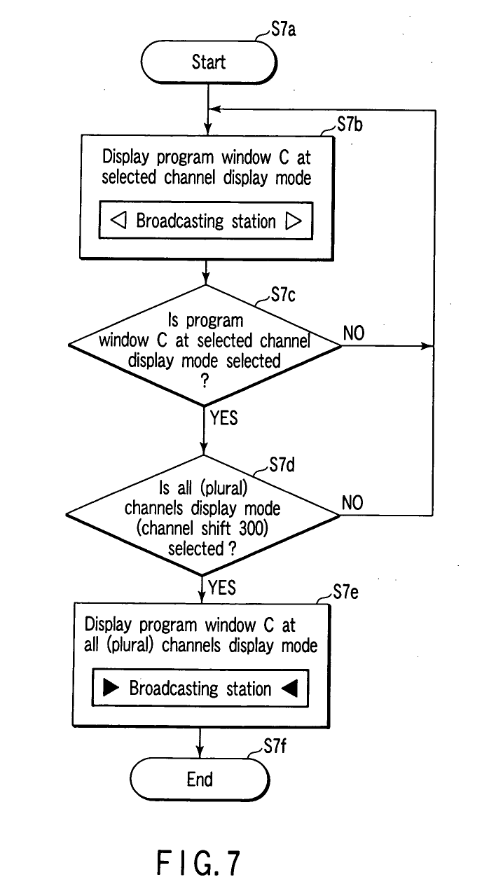

FIG. 7 is a flowchart showing the exemplary action of switching the channel display from the selected channel display mode to the full channel display mode according to the first embodiment.

Denoted by S7a is the start operation. The action is then advanced to block S7b where the program display window C on the electronic program guide is displayed at the selected channel display mode. This is followed by block S7c.

In block S7c, it is examined whether the program display window C at the selected channel display mode is selected or not by the user. It is not needed to fill all the area of the program display window C but one program may simply be displayed such as “Today's news and sports MAX” 602 shown in FIG. 6.

When it is judged that the program display window C on the electronic program guide screen is selected by the user (yes at S7c), the action moves to block S7d. If it is judged that the program display window C is not selected by the user (no at S7c), the action returns back to block S7b and the above-described operation is repeated.

In block S7d, it is examined whether the full channel display mode is demanded or not (by the user operating the channel shift keys). When it is judged that the full channel display mode is demanded (yes in block S7d), the action moves to block S7e. If it is judged that the full channel display mode is not demanded (no in block S7d), the action is returned back and the previous block S7b is repeated.

In block S7e, the channel (program) display window C is shifted from the selected channel display mode to the full channel display mode. This is followed by block S7f. In block S7f, the action is ended.

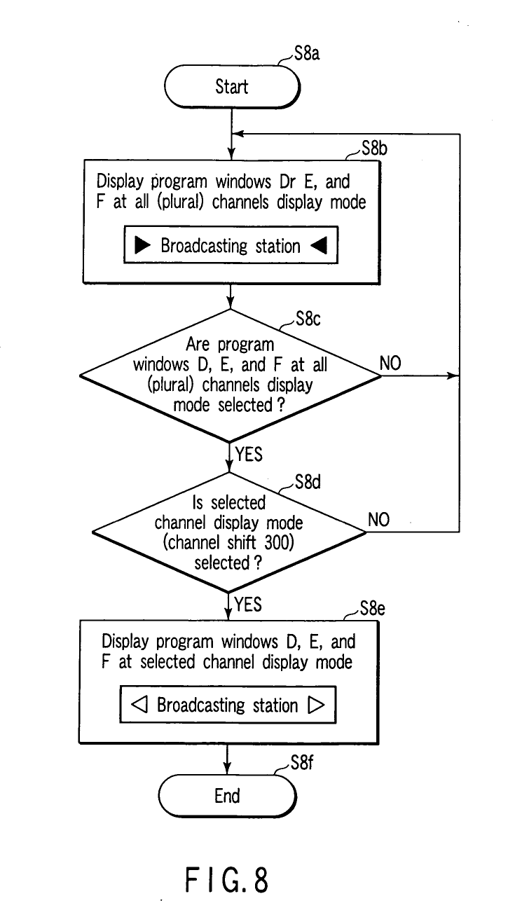

FIG. 8 is a flowchart showing the action of switching from the full channel display mode to the selected channel display mode according to the first embodiment.

Denoted by S8a is the start operation. The action is then advanced to block S8b where the program display windows D, E, and F on the electronic program guide are displayed at the full channel display mode. This is followed by block S8c.

In block S8c, it is examined whether the program display windows D, E, and F at the full channel display mode is selected or not by the user. It is not needed to fill all the area of the program display windows D, E, and F but one program may simply be displayed similar to that described above.

When it is judged that the program display windows D, E, and F at the full channel display mode are selected by the user (yes at S8c), the action moves to block S8d. If it is judged that the program display windows D, E, and F are not selected by the user (no at S8c), the action returns back to block S8b and the above described operation is repeated.

In block S8d, it is examined whether the selected channel display mode is demanded or not (by the user operating the channel shift keys). When it is judged that the selected channel display mode is demanded (yes in block S8d), the action moves to block S8e. If it is judged that the selected channel display mode is not demanded (no in block S8d), the action is returned back and the previous block S8b is repeated.

In block S8e, the channel (program) display windows D, E, and F are shifted from the full channel display mode to the selected channel display mode. This is followed by block S8f. In block S8f, the action is ended.

As described, the first embodiment allows the selected one of the plural channels to be displayed thus improving the visuality of the electronic program guide. Also, a group of the channels determined over the content of the programs is displayed in the electronic program guide, which can thus be improved in the visuality. Moreover, the switching from the selected channel display mode to the full channel display mode or from the full channel display mode to the selected channel display mode can readily be made. Accordingly, the electronic program guide can be enhanced in the accessibility for every user.

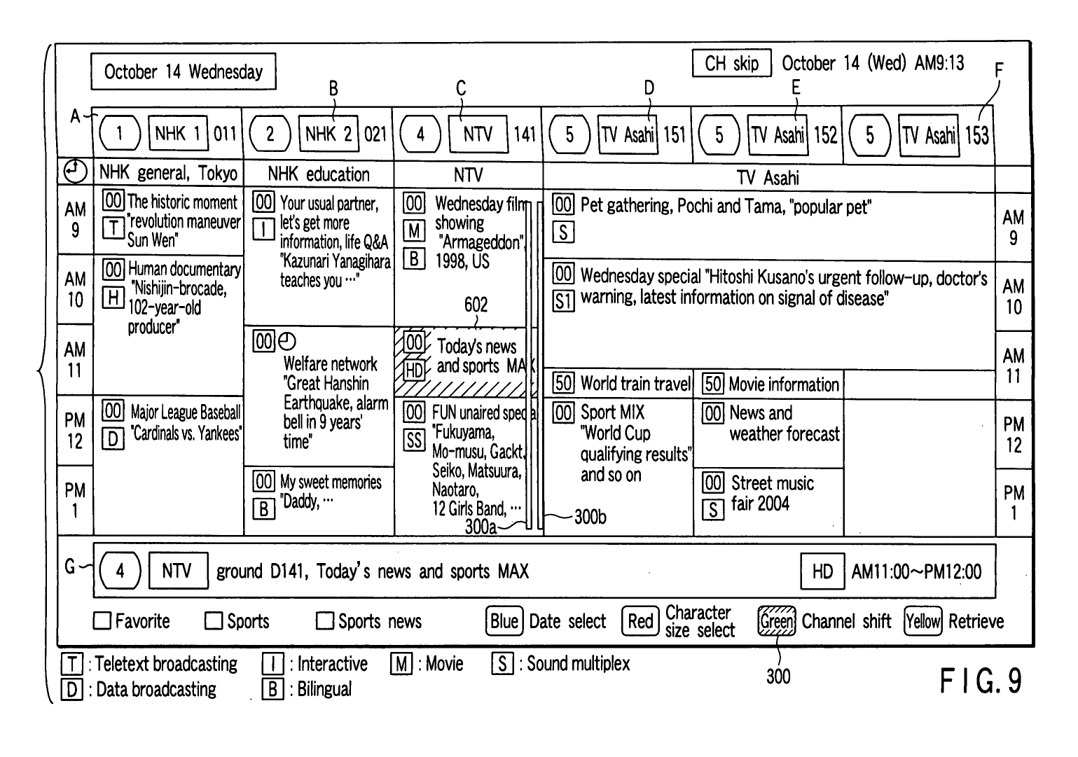

A second embodiment of the present invention will be described. In FIG. 9, like components are denoted by like numerals. More particularly, the NTV (channel number 141) window denoted by C is displayed at the selected channel display mode. While the NTV station has three different channels (141, 142, and 143), its window on the electronic program guide screen displays the selected channel 141 as shown in FIG. 9.

In particular, the channel window at the selected channel display mode is accompanied with two markers denoted by 300a and 300b. According to one embodiment of the invention, the marker 300a and 300b are represented as bars, namely marker bars, cascading over at least two programs visually represented in channel display window C.

The selected one of the three available channels of the TV broadcasting station is only displayed in the channel display window C. The other two channels not displayed are thus expressed by the two marker bars 300a and 300b.

This allows the user to acknowledge the other two channels in addition to the selected channel displayed in the channel display window C (of the NTV station).

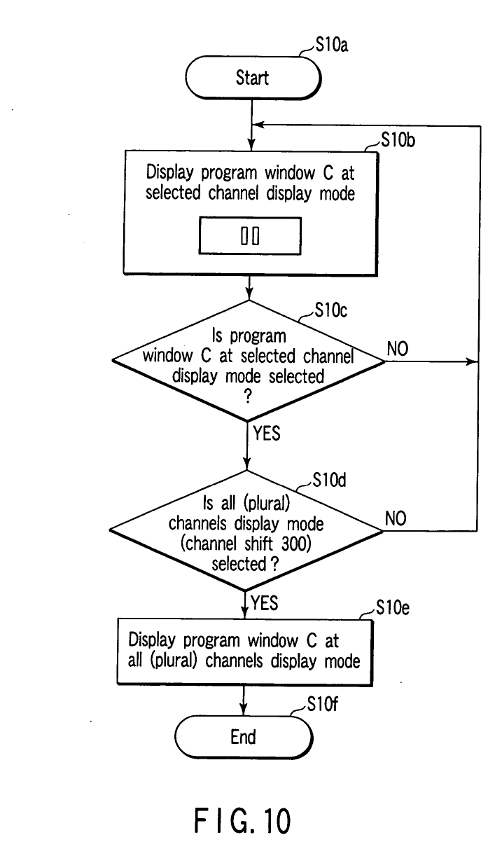

FIG. 10 is a flowchart showing the action of switching from the selected channel display mode to the full channel display mode according to the second embodiment.

Denoted by S10a is the start operation. The action is then advanced to block S10b where the program display window C on the electronic program guide is displayed at the selected channel display mode. This is followed by block S10c.

In block S10c, it is examined whether the program display window C at the selected channel display mode is selected or not by the user. It is not needed to fill all the area of the program display window C but one program may simply be displayed such as “Today's news and sports MAX” 602 shown in FIG. 9.

When it is judged that the program display window C on the electronic program guide screen is selected by the user (yes at S10c), the action moves to block S10d. If it is judged that the program display window C is not selected by the user (no at S10c), the action returns back to block S10b and the above-described operation is repeated.

In block S10d, it is examined whether the full channel display mode is demanded or not (by the user operating the channel shift keys). When it is judged that the full channel display mode is demanded (yes in block S10d), the action moves to block S10e. If it is judged that the full channel display mode is not demanded (no in block S10d), the action is returned back and the previous block S10b is repeated.

In block S10e, the channel (program) display window C is shifted from the selected channel display mode to the full channel display mode. This is followed by block S10f. In block S10f, the action is ended.

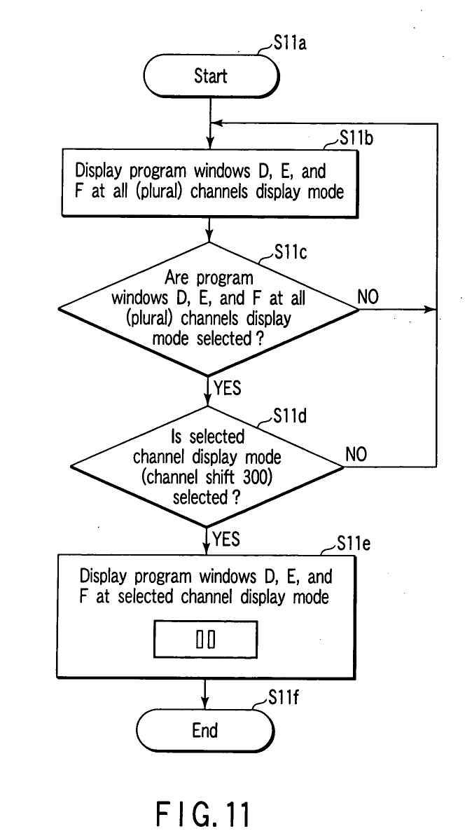

FIG. 11 is a flowchart showing the action of switching from the full channel display mode to the selected channel display mode according to the second embodiment.

Denoted by S11a is the start operation. The action is then advanced to block S11b where the program display windows D, E, and F on the electronic program guide are displayed at the full channel display mode. This is followed by block S11c.

In block S11c, it is examined whether the program display windows D, E, and F at the full channel display mode is selected or not by the user. It is not needed to fill all the area of the program display windows D, E, and F but one program may simply be displayed similar to that described above.

When it is judged that the program display windows D, E, and F at the full channel display mode are selected by the user (yes at S11c), the action moves to block S11d. If it is judged that the program display windows D, E, and F are not selected by the user (no at S11c), the action returns back to block S11b and the above-described operation is repeated.

In block S11d, it is examined whether the selected channel display mode is demanded or not (by the user operating the channel shift keys). When it is judged that the selected channel display mode is demanded (yes in block S11d), the action moves to block S11e. If it is judged that the selected channel display mode is not demanded (no in block S11d), the action is returned back and the previous block S11b is repeated.

In block S11e, the channel (program) display windows D, E, and F are shifted from the full channel display mode to the selected channel display mode. This is followed by block S11f. In block S11f, the action is ended.

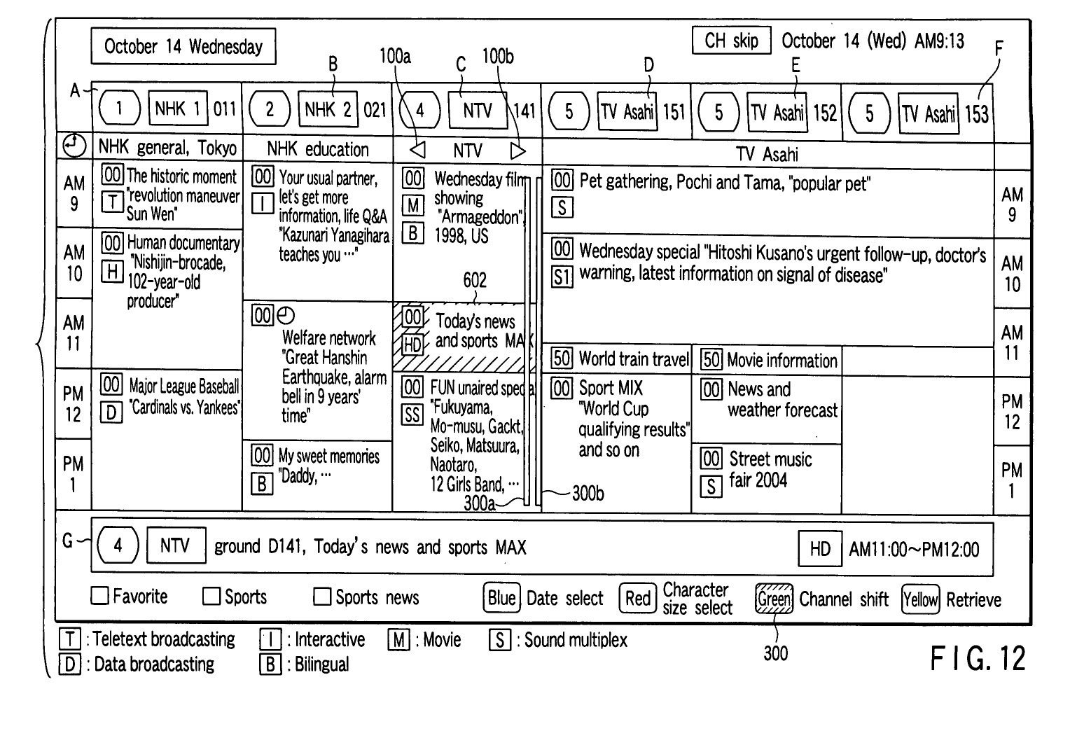

FIG. 12 illustrates a modification of the screen of the electronic program guide according to the second embodiment. More particularly, according to this embodiment of the invention, two substantially triangle symbols 100a and 100b are provided on both sides of the NTV station in the channel (program) display window C in addition to the selected channel display mode shown in FIG. 9. This permits the user to readily access the other channels of the station.

As described, the second embodiment allows the selected one of the plural channels to be displayed thus improving the visuality of the electronic program guide. Also, a group of the channels determined over the content of the programs is displayed in the electronic program guide, which can thus be improved in the visuality. Accordingly, the electronic program guide can be enhanced in the accessibility for every user.

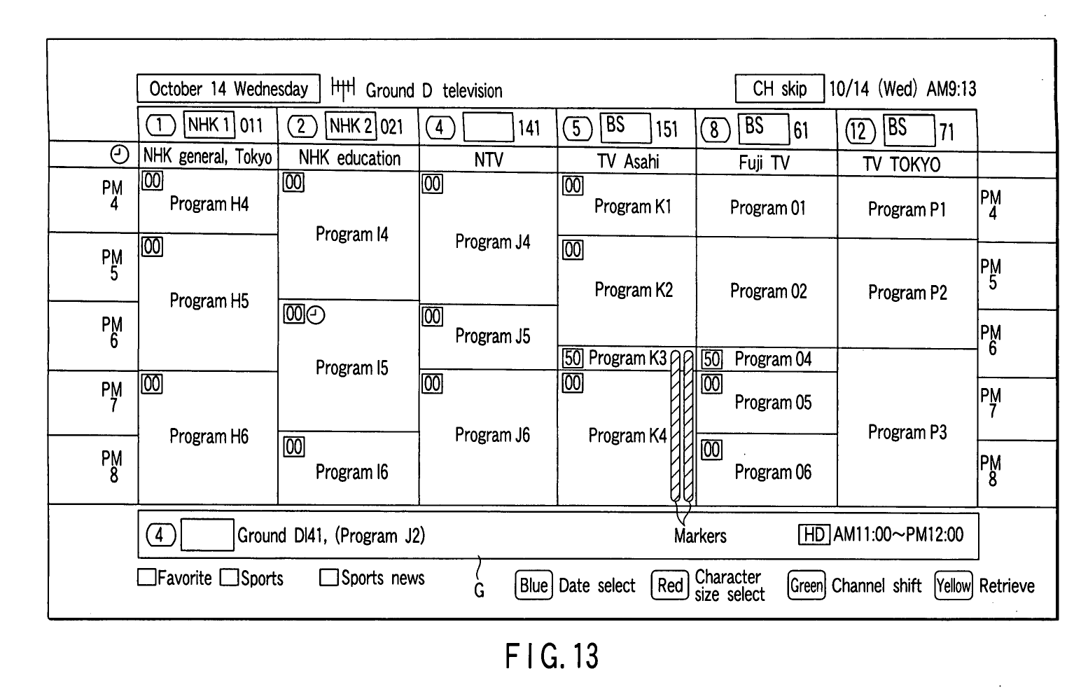

A third embodiment of the present invention will now be described. FIG. 13 illustrates a display screen at the selected channel display mode according to the third embodiment. As shown, each of the six display windows A to F is filled with a single television broadcasting station. This results from the TV Asahi station display window of FIG. 9 compressed in the size. While the program is shared by its different channels, the station window can be decreased with no trouble.

During the time other than the sharing of the program, each channel provides one program. In the second embodiment, the marker bars are displayed for indicating that more channels are available in addition to the selected channel being displayed. Those bars are denoted by the hatching in FIG. 13. The bar schematically represents the compression of the display and the number of the bars is the number of the available channels. The two marker bars shown in FIG. 13 represent that two more channels are available from the same station which are not broadcasting programs K3 and K4. Programs K1 and K2 are aired on all channels of the TV Asahi station, and hence, no marker bars are represented.

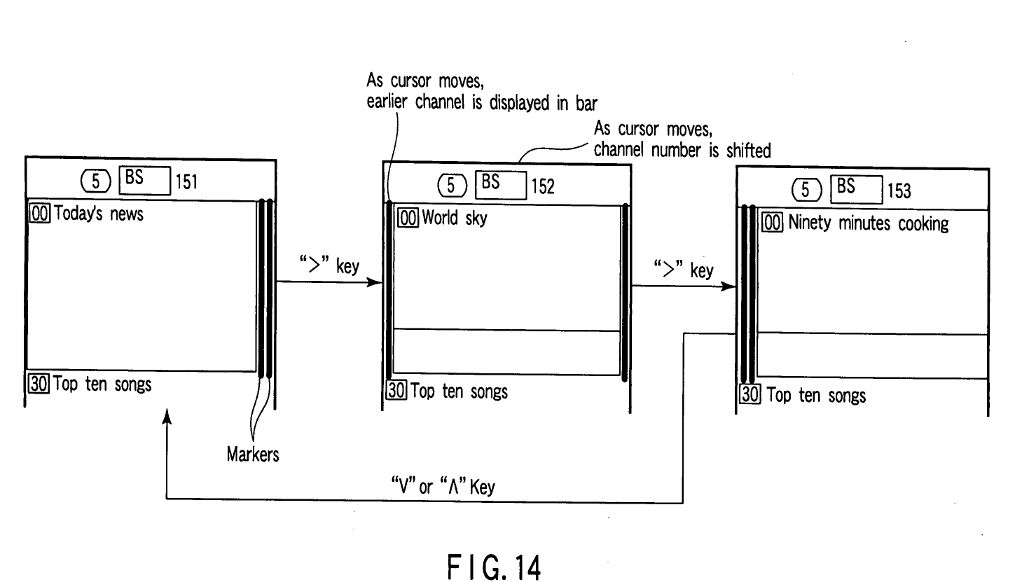

FIG. 14 is a schematic view illustrating a transition of screens displayed by the user operating the remote control 17. At the beginning, the selected channel 151 is displayed in the TV Asahi station window. As the two marker bars being displayed at the right, they notify the user of the two available channels of which the numbers are greater.

When the “>” key of the cursor 17f on the remote control 17 is depressed, the screen is scrolled to display the succeeding channel 152. Simultaneously, the selected channel 151 is compressed to appear as a marker bar. As a result, the two marker bars are displayed separately at both, left and right sides. When the “>” key is depressed again, the channel 152 appears and the two marker bars are displayed both at the left side. Then, when the “V ” or “Λ” key of the cursor 17f is pressed down, the screen is returned to the beginning displaying the selected channel 151.

The third embodiment permits the selected channel to be determined at each television broadcasting station. The selected channel of every station may be assigned to the earliest channel of which the number is smallest, the most recently selected channel, the channel set at the default setting, or any desired channel determined on the basis of a particular item. As the selected channel is predetermined at each broadcasting station, the EPG screen can equally be shared by all the broadcasting stations, each displaying one channel.

Accordingly, as its screen displays a more number of the television broadcasting stations at once, the electronic program guide can be improved in the visuality and the legibility. Also, since the other channels than the selected channel of each station are indicated by the marker bars at its screen, the electronic program guide can be increased in the user interface performance. The accessibility to the electronic program guide by the user can be improved with the screen display being highly legible.

It would be understood that the present invention is not limited to the foregoing embodiments but various changes and modifications are possible without departing from the sprits and scope of the present invention. For embodying the present invention, the arrangements disclosed in the embodiments may be feasible in any combination. For example, some elements in the embodiments can be eliminated for simplicity of the arrangement. Alternatively, some elements in the embodiments can be combined to construct a different arrangement.

What is claimed is:

1. A digital television receiver, comprising:
an on-screen display (OSD) generator;
a controller coupled to the OSD generator, the controller operating in combination with the OSD generator to produce an electronic program guide displaying programs, the electronic program guide including a display window in a first display mode where program data corresponding to a selected channel of a plurality of channels provided by a first broadcast station is displayed in the display window as a representative channel; and
a processor coupled to the OSD generator and the controller, the processor to output the electronic program guide and to output information identifying that the selected channel is the representative channel.

2. A digital television receiver according to claim 1, wherein the processor is a graphics processor.

3. A digital television receiver according to claim 1, wherein the controller to place the display window in a second display mode in response to an event, the display window displaying program data for all of the plurality of channels.

4. A digital television receiver according to claim 1, wherein the controller receiving the program data corresponding to the selected channel of the plurality of channels over one of a network and a memory card.

5. A digital television receiver according to claim 1, wherein the plurality of channels include at least one high definition channel and at least one standard channel.

6. A digital television receiver according to claim 1, wherein the processor outputting the information being one or more displayable objects within the display window, the one or more objects corresponding in number to a number of channels forming the plurality of channels minus one.

7. A digital television receiver according to claim 6, wherein the one or more objects are one or more markers positioned vertically across the display window.

8. A digital television receiver according to claim 7, wherein the processor vertically positions a first and second markers of the one or more markers proximate to a first edge of the display window to identify two channels greater in channel number that the selected channel.

9. A digital television receiver according to claim 8, wherein the first marker is positioned vertically along the first edge of the display window while the second marker is positioned proximate to a second edge of the display window differing from the first edge to identify that the selected channel is a channel number greater than one of the plurality of channels and lesser than another channel of the plurality of channels.

10. A digital television receiver according to claim 1, wherein the controller to further produce the electronic program guide including a display window in a second display mode where program data corresponding to a plurality of channels provided by a second broadcast station is displayed.

11. A method comprising:
acquiring program data;
generating an electronic program guide including a display window in a first display mode, the display window to display program data associated with a selected channel of a plurality of channels, the selected channel displayed as a representative channel in the display window; and
outputting the electronic program guide along with information indicating that the display window is the representative channel.

12. A method according to claim 11 further comprising placing the display window into a second display mode, the display window to display program data associated with all of the plurality of channels.

13. A method according to claim 11, wherein the plurality of channels include at least one high definition channel and at least one standard channel.

14. A method according to claim 11, wherein the outputting of the information including overlaying at least one displayable object over a portion of the display window, the at least one object corresponding in number to channels of the plurality of channels with program data not being displayed while the display window is in the first display mode.

15. A method according to claim 11, wherein outputting of the information including overlaying a plurality of markers over a portion of the display window, the plurality of markers corresponding in number to a number of the plurality of channels minus one.

16. A method according to claim 15, wherein the outputting of the information including overlaying the plurality of markers includes overlaying a first and second markers proximate to a first edge of the display window to identify two channels greater in channel number that the selected channel.

17. A method according to claim 15, wherein the outputting of the information including overlaying the plurality of markers includes overlaying a first marker proximate to a first edge of the display window and overlaying a second marker proximate to a second edge of the display window opposite the first edge so as to indicate that the selected channel is a channel number greater than a channel associated with the second marker and lesser than a channel associated with the first marker.

18. A method comprising:
acquiring program data by a digital television receiver; and
generating an electronic program guide, including generating a first display window in a first display mode, the first display window displaying a portion of the program data associated with a selected channel of a first plurality of channels, the selected channel being displayed as a representative channel in the display window, and
generating a second display window in a second display mode, the second display window displaying a portion of the program data associated with a second plurality of channels differing from the first plurality of channels.

19. A method according to claim 18 further comprising overlaying at least one marker, being a displayable object, proximate to a first edge of the first display window to identify how many channels of the plurality of channels provided by a first broadcast station are hidden from view.

20. A method according to claim 18 further comprising:
overlaying a first marker, being an displayable object, proximate to a first edge of the first display window; and
overlaying a second marker, being an displayable object, proximate to a second edge of the first display window opposite the first edge in order to identify that the selected channel displayed in the first display window is a channel number between a channel associated with the second marker and a channel associated with the first marker.
